(19) United States
(12) Patent Application Publication
(10) Pub. No.: US 2008/0048357 A1
(43) Pub. Date: Feb. 28, 2008

(54) Methods for fabricating solid oxide fuel cells

(75) Inventors: Hua Wang, Clifton Park, NY (US); Kurtis Montgomery, Torrance, CA (US); Wayne Hasz, Pownal, VT (US); Vishal Agarwal, Redondo Beach, CA (US); Surinder Pabla, Greer, SC (US); Warren Nelson, Clifton Park, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric

(21) Appl. No.: 11/509,964

(22) Filed: Aug. 25, 2006

(51) Int. Cl. B29C 47/00; B29C 49/00

(52) U.S. Cl. 264/211.11; 264/540

(57) ABSTRACT

A method of fabricating a solid oxide fuel cell that includes the steps of: (a) inputting raw materials for a layer of the solid oxide fuel cell into a screw extruder; (b) mixing the raw materials into a mixture as the raw materials pass through the screw extruder; (c) de-airing the mixture of raw materials as the raw materials pass through the screw extruder; and (d) extruding, the mixture through an opening at a downstream end of the screw extruder. The screw extruder may be a twin-screw extruder.

### TECHNICAL FIELD

This present application relates generally to methods for fabricating fuel cells. More specifically, but not by way of limitation, the present application relates to methods for fabricating the layers of a multilayer solid oxide fuel cell.

### BACKGROUND OF THE INVENTION

A fuel cell is a galvanic conversion device that electrochemically reacts a fuel with an oxidant within catalytic confines to produce a DC electrical output. In a fuel cell, cathode material defines the passageways for the oxidant and anode material defines the passageways for the fuel, and an electrolyte separates the cathode and anode materials. The fuel and oxidant fluids, typically as gases, are continuously passed through the cell passageways separated from one another. The fuel and oxidant discharges from the fuel cell generally remove the reaction products and heat generated in the cell. The fuel and oxidant are the working fluids and, as such, are typically not considered an integral part of the fuel cell itself.

One type of fuel cell is a solid oxide fuel cell. Typically, solid oxide fuel cells react hydrogen or a hydrocarbon fuel and an oxidant, such as oxygen or air, across an oxide electrolyte. Solid oxide fuell cells generally operate at temperatures between 700° and 1,100° C. (1,292° and 2012° F.).

In operation, the hydrogen passing through the solid oxide fuel cell reacts with oxide ions on the anode to yield water, which is carried off in the fuel flow stream, with the release of electrons into the anode material. The oxygen reacts with the electrons on the cathode surface to form the oxide ions which then pass into the electrolyte material. Electrons flow from the anode through an appropriate external load to the cathode, and the circuit is closed internally by the transport of oxide ions through the electrolyte. The reaction process is known and more thoroughly delineated in U.S. Pat. Nos. 4,499,663 and 4,816,036, which are incorporated herein in their entirety.

The electrolyte isolates the fuel and oxidant gases from one another while providing a medium allowing the oxygen ion transfer, as well as voltage buildup on opposite sides of the electrolyte. Fuel and oxidant must diffuse away from the flow stream in the respective passageways to the electrolyte and react at or near the boundary of the electrodes (anode or cathode), and electrolyte, where electrochemical conversion occurs. The electrodes provide paths for the internal movement of electrical current within the fuel cell to the cell terminals, which also connect with an external load. The operating voltage across each cell is on the order of 0.7 volts so the individual cells must be placed in electrical series, i.e., “stacked,” to obtain a useful load voltage.

As known in the art, solid oxide fuel cells may be produced by fabricating sheets of the individual layers (i.e., the electrolyte layer, the anode layer, and the cathode layer) and then laminating the sheets together to form a solid oxide fuel cell, which may then be further processed for use in fuel cell stacks. However, as discussed in more detail below in the text corresponding to FIG. 1, the conventional methods for fabricating the individual fuel cell layers and then laminating the layers together to form a fuel cell require an inordinately high number of separate process steps. The resulting complexity associate with the conventional methods make the fabrication process time consuming, inefficient, labor intensive and costly. Thus, there is a need for improved methods for fabricating the separate layers of a multilayer solid oxide fuel cell, which may include the fabrication of an anode-electrolyte layer, and/or a multilayer solid oxide fuel cell.

### BRIEF DESCRIPTION OF THE INVENTION

The present application thus may describe a method of fabricating a solid oxide fuel cell that includes the steps of: (a) inputting raw materials for a layer of the solid oxide fuel cell into a screw extruder; (b) mixing the raw materials into a mixture as the raw materials pass through the screw extruder; (c) de-airing the mixture of raw materials as the raw materials pass through the screw extruder; and (d) extruding the mixture through an opening at a downstream end of the screw extruder. The inputting may include metering the raw materials into the screw extruder in a desired ratio.

The screw extrude may be a twin-screw extruder. In some embodiments, the mixing may include blending the raw materials as the raw materials pass through a barrel of the screw extruder, and high shear mixing the raw materials as the raw materials pass through the barrel of the screw extruder. The mixing further may include mixing the raw materials into an approximate homogeneous physical mixture.

In some embodiments, the opening may be a sheet die. The opening may be a narrow slit such that when the raw materials are extruded through the opening the raw materials form a substantially flat thin sheet. The de-airing may include creating at least a partial vacuum at one or more de-airing ports that are positioned along a barrel of the screw extruder.

In some embodiments to claim 1, steps (a) through (d) may be used to fabricate an electrolyte layer and a first anode layer. In such embodiments, the method further may include the steps of: laminating the electrolyte layer to the first anode layer to create a first anode-electrolyte layer, and passing the first anode-electrolyte layer through a roll mill as necessary to reduce the thickness of the first anode-electrolyte layer to a desired measurement.

In some embodiments, the steps (a) through (d) may be repeated to fabricate a second anode layer. In such an embodiment, the method further may include the steps of laminating the second anode layer to the first anode-electrolyte layer to create a second anode-first anode-electrolyte layer, and passing the second anode-first anode-electrolyte layer through a roll mill as necessary to reduce the thickness of the second anode-first anode-electrolyte layer to a desired measurement.

In some embodiments, steps (a) through (d) may be repeated to fabricate an electrolyte layer, a first anode layer, a second anode layer, and a third anode layer. In such embodiments, the step of extruding the mixture through an opening at a downstream end of the screw extruder may include the steps of co-extruding the electrolyte layer and the first anode layer such that the output renders a co-extruded electrolyte-first anode layer of a desired thickness ratio, and co-extruding the second anode layer and the third anode layer such that the output renders a co-extruded second anode-third anode layer of a desired thickness ratio. The method further may include the step of laminating the co-extruded electrolyte-first anode layer to the co-extruded second anode-third anode layer.

The present application further may describe a method of fabricating a solid oxide fuel cell that includes the steps of: (a) blending the raw materials of a layer of the solid oxide fuel cell; (b) mixing the raw materials of a layer of the solid oxide fuel cell; (c) high shear mixing the raw materials of a layer of the solid oxide fuel cell; (d) inputting the raw materials of a layer of the solid oxide fuel cell into an screw extruder; (e) de-airing the mixture of raw materials as the raw materials pass through a barrel of the screw extruder; and (f) extruding the mixture through a sheet die at a downstream end of the barrel. The screw extruder may be a single-screw extruder.

In some embodiments, steps (a) through (f) may be repeated to fabricate an electrolyte layer and first anode layer. In such embodiments, the method further may include the steps of laminating the electrolyte layer to the first anode layer to create a first anode-electrolyte layer and passing the first anode-electrolyte layer through a roll mill as necessary to reduce the thickness of the first anode-electrolyte layer to a desired measurement.

In some embodiments, steps (a) through (f) may be repeated to fabricate a second anode layer. In such embodiments, the method further may include the steps of laminating the second anode layer to the first anode-electrolyte layer to create a second anode-first anode-electrolyte layer, and passing the second anode-first anode-electrolyte layer through a roll mill as necessary to reduce the thickness of the second anode-first anode-electrolyte layer to a desired measurement.

In some embodiments steps (a) through (f) may be repeated to fabricate an electrolyte layer, a first anode layer, a second anode layer, and a third anode layer. In such embodiments, the step of extruding the mixture through a sheet die at a downstream end of the barrel may include the steps of co-extruding the electrolyte layer and the first anode layer such that the output renders a co-extruded electrolyte-first anode layer of a desired thickness ratio, and co-extruding the second anode layer and the third anode layer such that the output renders a co-extruded second anode-third anode layer of a desired thickness ratio. The method further may include the step of laminating the co-extruded electrolyte-first anode layer to the co-extended second anode-third anode layer.

These and other features of the present application will become apparent upon review of the following detailed description of the preferred embodiments when taken in conjunction with the drawings and the appended claims.

### BRIEF DESCRIPTION OF THE DRAWINGS

FIG. 1 is a flow diagram demonstrating known solid oxide fuel cell fabrication process.

FIG. 2 is a cross-section view of a typical single-screw extruder, with which an exemplary embodiment of the present application may be practiced.

FIG. 3. is a flow diagram demonstrating an exemplary embodiment of the present application.

FIG. 4 is a cross-section view of a typical twin-screw extruder, with which an exemplary embodiment of the present application may be practiced.

FIG. 5 is a flow diagram demonstrating an alternative exemplary embodiment of the present application.

FIG. 6 is a flow diagram demonstrating an alternative exemplary embodiment of the present application.

### DETAILED DESCRIPTION OF THE INVENTION

The present application describes methods of fabricating the individual layers of a multilayer solid oxide fuel cell, the anode-electrolyte layer of a multilayer solid oxide fuel cell, and/or a multilayer solid oxide fuel cell through the combination of extrusion and tape calendering. The extrusion process may be used to form the separate layers of a multilayer solid oxide fuel cell such that the number of separate process steps is reduced. The calendering process may be used to further reduce the thickness of the multilayered tape such that the electrolyte layer is reduced to a thickness that may be used efficiently in reduced temperature solid oxide fuel cell operation.

The individual layers that make up a multilayer solid oxide fuel cell must be thin (approximately 0.002 to 0.05 cm) to minimize resistance losses. However, the individual layers still must have sufficient structural integrity to withstand the fluid pressures generated by the gas flow, the thermal stresses associated with the high temperature environment of the fuel cell, and the mechanical stresses associated with fuel cell stacks. Because of these requirements, fabricating the layers that make up multilayer solid oxide feul cells is often difficult and expensive.

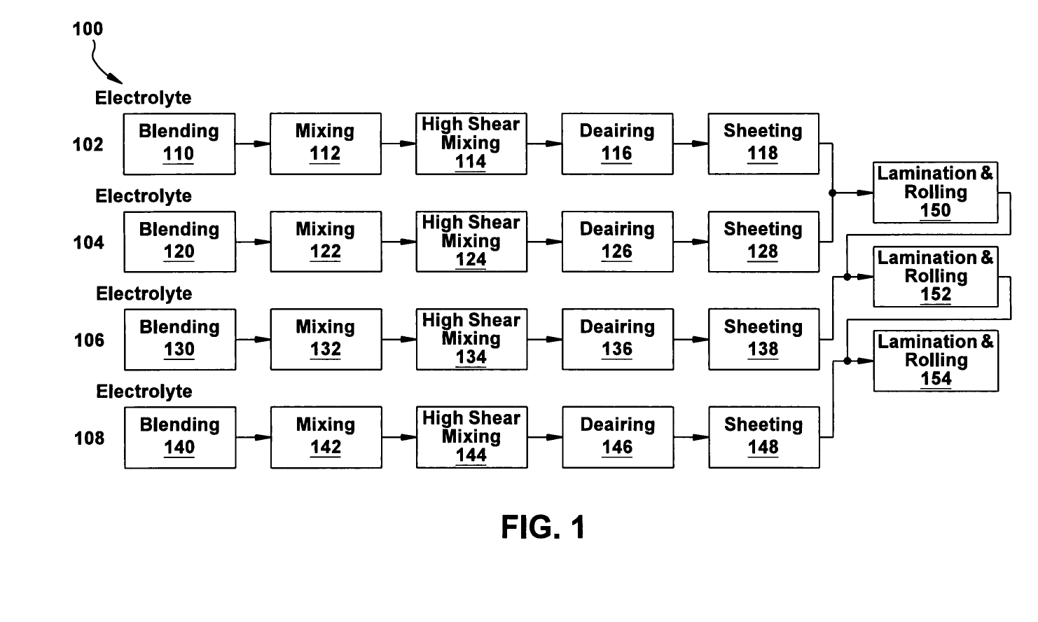

In general, conventional methods and processes for fabricating multilayer solid oxide fuel cell layers require a significant number of separate, labor-intensive process steps. FIG. 1 demonstrates a conventional process for fabricating the individual layers of a solid oxide fuel cell, a process 100. The process 100 may include the following steps: (1) blending; (2) mixing; (3) high shear mixing; (4) de-airing; and (5) sheeting. These steps are repeated for each of the layers in a multilayer solid oxide fuel cell. In some cases the steps are repeated for the sub-layers that make up one of the layers of the fuel cell. For example, FIG. 1 demonstrates the fabrication of an anode-electrolyte layer (i.e., two-thirds of the solid oxide fuel cell). The fabrication of the anode-electrolyte layer includes repeating the steps four times to produce three anode layers and one electrolyte layer, which are laminated together toward the end of process 100.

In general, the fabrication of a solid oxide fuel cell may begin with an electrolyte layer being applied in succession to several anode layers. This may be done for several reasons. First, at this stage in the fabrication, the electrolyte has chemical reactivity issues with the cathode layer that prevent it from being applied to the cathode. Second, having the anode layer be comprised of several layers (each with its own unique physical characteristics) allows the layer to be engineered such that its operation is improved. For example, the porosity of each anode layer may be different such that, through the cross-section of the resulting anode layer, the porosity of the anode layer decreases as distance to the electrolyte decreases. Such non-uniformity may provide improvement to the operation of the fuel cell. Third, because each the laminated layers is passed through a roll mill, the lamination of the electrolyte layer to successive anode layers allows the thickness of the electrolyte in the resulting anode-electrolyte layer to be reduced to a desired measurement through the subsequent roll milling. Thus, in general, the process 100 for fabricating an anode-electrolyte layer for a multilayer solid oxide fuel cell may include four sub-processes: an electrolyte sub-process 102; a first anode sub-process 104; a second anode sub-process 106; and a third anode sub-process 108, where the electrolyte layer and each of the individual layers of the anode layer are fabricated.

The electrolyte sub-process 102 may include the following steps. At a blending step 110, the raw materials for the electrolyte layer may be blended together per methods known in the art. At a mixing step 112, the blended electrolyte layer raw materials may be milled per methods known in the art to improve the mixing of the components. At a high shear mixing step 114, binders may be added to the electrolyte raw materials and the binders and electrolyte raw materials may be mixed in a high shear mixer per methods known in the art. At a de-airing step 116, the mixed materials may be de-aired. This may be done by passing the mixture though a roll mill such that any air bubbles are removed from the mixture. At a sheeting step 118, the de-aired material may be sheeted into a layer or tape of the desired dimensions by repeatedly passing the mixture through a roll mill of a desired dimension. Thus, the fabrication of a single layer requires at least five separate steps.

These five steps then may be repeated for each of the layers of the anode layer (see steps 120-128 for the first anode layer, steps 130-138 for the second anode layer, and steps 140-148 for the third anode layer). In all, the fabrication of the four layers requires at least twenty separate steps.

After the four layers have been fabricated, the separate sheets may be laminated together to create the anode-electrolyte layer. In general, the process steps required to complete the lamination are as follows. First, at step 150, the electrolyte layer and the first anode layer may be laminated together pursuant to methods known in the art. Once laminated together, the resulting electrolyte-first anode layer may be passed through a roll mill until its thickness is reduced to a desired measurement. At step 152, the second anode layer may be laminated to the electrolyte-first anode layer. Once these layers are laminated together, the resulting electrolyte-first anode-second anode layer may be passed through a roll mill until its thickness is reduced to a desired measurement. Finally, at step 154, the third anode layer may be laminated to the electrolyte-first anode-second anode layer. Once these layers are laminated together, the resulting electrolyte-first anode-second anode-third anode layer may be passed through a roll mill until its thickness is reduced to a desired measurement.

Thus, after the twenty-three separate process steps of the process 100, a multilayer anode-electrolyte layer of the desired dimensions has been fabricated. To complete the process, a cathode layer (not shown) may be fabricated using a similar process as the one described above or other process known in the art. Then, the cathode layer may then be screen printed, laminated or applied using other known processes to the anode-electrolyte layer such that a multilayer solid oxide fuel cell is formed. The multilayer solid oxide fuel cell then may be further formatted as necessary for use in fuel cell stacks to produce electricity.

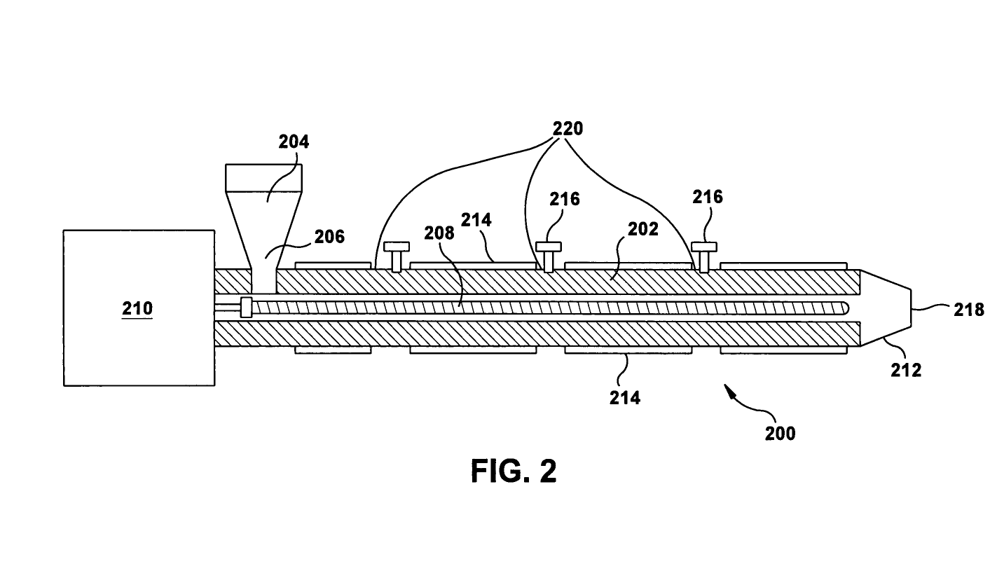

FIG. 2 demonstrates an extruder 200. The extruder 200 may be any type of extruder, such as a single-screw extruder, a twin-screw extruder, or similar extruder. In some exemplary embodiments, the extruder 200 may be a single-screw extruder, a simplified diagram of which is shown in FIG. 2. The extruder 200 may include a barrel 202 arranged horizontally for receiving the component materials that form the composition for the resulting extruded material.

The component materials for the resulting extruded material may be placed into a hopper 204. The component materials may be pelletized to aid in the mixing within the extruder 200. The hopper 204 may communicate with a port 206 in the barrel 202 so that the component materials placed in the hopper 204 may be delivered through the port 206 into the interior of the barrel 202. The extruder 200 further may include a screw 208 disposed in the interior of the barrel 202. A drive 210 mounted at the rear or upstream end of the barrel 202 may drive the screw 208 so that it undergoes a rotating motion relative to the axis of the barrel 202. As the screw 208 rotates, it may push or advance axially the component materials introduced into the interior of the barrel 202. In addition, the screw 208 may mix the component materials together such that the resulting extruded material is a substantially uniform physical mixture of the component materials. While not shown in the simplified diagram of FIG. 2, the screw 208 may include specially designed mixing sections adapted to provide enhanced mixing capabilities so as to thoroughly mix the components materials.

The screw 208 may advance the resulting mixture of the component materials to an output die 212 disposed at the forward or downstream end of the barrel 202. The extruder 200 may include electric heating bands 214 that supply heat to the barrel 202. The temperature of the barrel may be measured by the thermocouples 216. The heat provided by the heating bands 214 may heat the component materials as the component materials move downstream toward the output die 212. Increasing the temperature of the component materials may aid in the mixing and the extrusion of the component materials. The extruder 200 further may include one or more de-airing ports 220 along the length of the barrel 202 that may be used to de-air the component materials as it moves from the port 206 to the output die 212. The de-airing of the component materials may be done via a vacuum created at the de-airing ports 220.

The output die 212 may include an opening 218. The rotational motion of the screw 208 may drag the component materials along the extruder such that a sufficient pressure is achieved to push, i.e., extrude, the component materials through the opening 218. The opening 218 may be in the form of a thin slot, which also may be known as a sheet die. Hence, when extruded through opening 218, the component materials may take the form of a substantially flat solidified thin sheet of material.

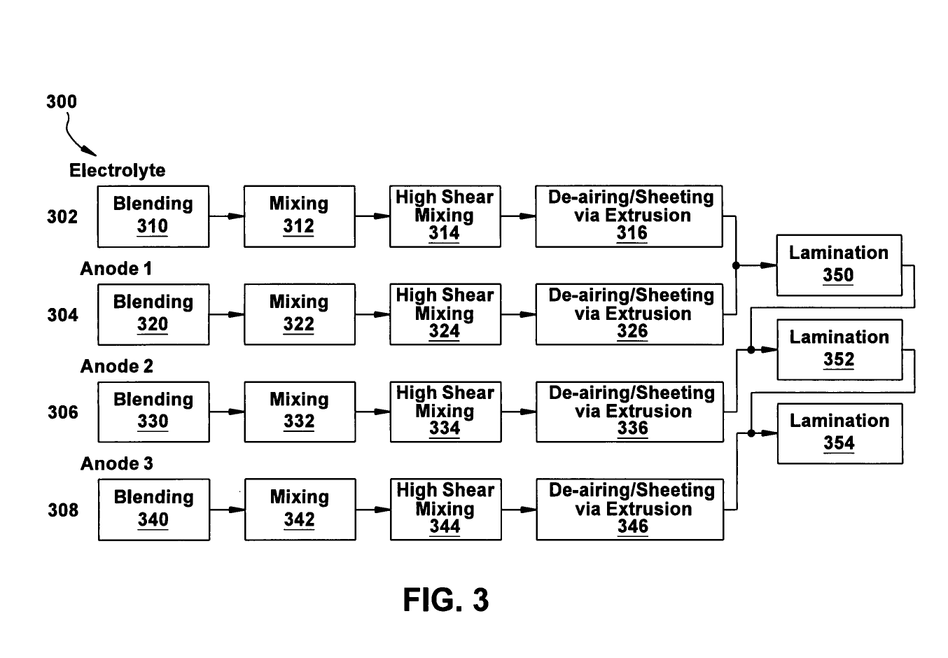

FIG. 3 demonstrates an exemplary embodiment of the present application, an extrusion process 300, in which the fabricating process for the layers of a multilayer solid oxide fuel cell have been simplified by using extrusion to reduce fabrication steps. Similar to the process 100 described above, the extrusion process 300 will be described in conjunction with a process for producing a anode-electrolyte layer. Those of ordinary skill in the art will appreciate that the extrusion process 300 is not limited to this application and that the description of extrusion process 300 in this context is exemplary only. The extrusion process 300 may be used to fabricate individual layers of a multilayer solid oxide fuel cell, an anode-electrolyte layer of a multilayer solid oxide fuel cell, and/or a multilayer solid oxide fuel cell. The extrusion process 300 for fabricating an anode-electrolyte layer of a multilayer solid oxide fuel cell generally may include four sub-processes: an electrolyte sub-process 302; a first anode sub-process 304; a second anode sub-process 306; and a third anode sub-process 308, where the electrolyte layer and each of the three anode layers are fabricated.

The electrolyte sub-process may include the following steps. At a blending step 310, the raw materials for the electrolyte may be blended together. At a mixing step 312, the blended electrolyte raw materials may be passed through a roll mill to further mix the components. At a high shear mixing step 314, binders may be added to the electrolyte raw materials and the binders and electrolyte raw materials may be mixed in a high shear mixer. After the electrolyte raw materials and binders are mixed in a high shear mixer in step 314 of the process, the electrolyte mixture may be pelletized and fed in the hopper 204 of the extruder 200. As the pelletized electrolyte raw materials pass along the length of the barrel 200 of the extruder 200, a vacuum may be created through the de-airing ports 220 in the barrel 202 and the electrolyte raw materials may be de-aired. The turning of screw 208 of the extruder 200 may force the de-aired electrolyte raw materials through the opening 218 in the output die 212, which may be positioned at the downstream end of the barrel 202. The opening 218 may be in the form of a thin slot. Therefore, when extruded through the opening 218, the de-aired electrolyte mixture may take the form of a substantially flat solidified thin sheet of electrolyte material. In this manner, a de-aired, electrolyte layer may be fabricated.

The use of the extruder 200 may allow for the consolidation of process steps contained in the process 100 described above. Specifically, the de-airing step 116 and the sheeting step 118 have been combined in one process step in the extrusion process 200. This consolidation may reduce labor and expense. Further, de-airing through the extrusion process may/allow for a more consistent product, as de-airing in this manner may be better controlled than de-airing through roll milling. The fabrication of a single layer of a multilayer solid oxide fuel cell thus may require four separate steps (as opposed to the five process steps described above in the process 100).

Each of these four steps then may be repeated for each of the other layers in the anode-electrolyte layer (see steps 320-326 for the first anode layer, steps 330-336 for the second anode layer, and steps 340-346 for the third anode layer). The fabrication of the four layers may result in sixteen separate process steps (as opposed to the twenty process steps described above in the process 100).

After the four layers of the anode-electrolyte layer have been fabricated, the separate sheets may be laminated together to create the anode-electrolyte layer. The process steps required to complete the lamination may be as follows. First, at a step 350, the electrolyte layer and the first anode layer may be laminated together. Once laminated together, the resulting layer may be passed through a roll mill until its thickness is reduced to a desired measurement. At step 352, the second anode layer may be laminated to the electrolyte-first anode layer. Once these layers are laminated together, the resulting layer may be passed through a roll mill until its thickness is reduced to a desired measurement. Finally, at a step 354, the third anode layer then may be laminated to the electrolyte-first anode-second anode layer. Once these layers are laminated together, the resulting layer may be passed through a roll mill until its thickness is reduced to a desired measurement. At this point, after nineteen separate process steps, an anode-electrolyte layer of a multilayer solid oxide fuel cell of a desired thickness has been fabricated.

To complete the process, a cathode layer (not shown) may be fabricated using a similar process as the one described above or other process known in the art. Then, the cathode layer then may be screen printed, laminated or applied using other known processes to the anode-electrolyte layer such that a multilayer solid oxide fuel cell is formed. The multilayer solid oxide fuel cell may be further formatted as necessary for use in fuel cell stacks to produce electricity.

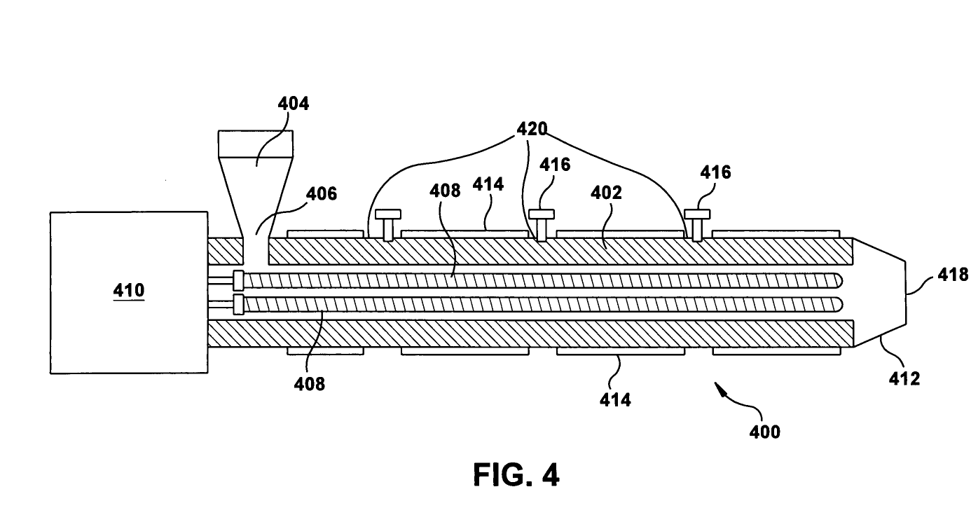

FIG. 4 demonstrates an twin-screw extruder 400. The twin-screw extruder 400 may be a commercially available twin-screw extruder, either counter-rotating, intermeshing or non-intermeshing though, as one of ordinary skill in the art would appreciate, a single-screw extruder or other similar extruder may be used as long as the mixing characteristics of the extruder are adequate or comparable to that of the twin-screw extruder 400. The twin-screw extruder 400 may include a barrel 402 arranged horizontally for receiving the component materials that form the active composition for the resulting extruded material.

The component materials for the resulting extruded material may be placed into a hopper 404. The component materials may be pelletized to aid in the mixing within the twin-screw extruder 400. The hopper 404 may communicate with a port 406 in the barrel 402 so that the component materials placed in the hopper 404 may be delivered through the port 406 into the interior of the barrel 402. The twin-screw extruder 400 further may include two screws 408 disposed in the interior of the barrel 402. A drive 410 mounted at the rear or upstream end of the barrel 402 may drive the two screws 408 so that the screws 408 undergo a rotating motion relative to the axis of the barrel 402. As the screws 408 rotate, they may push or advance axially the component materials introduced into the interior of the barrel 402. In addition, the two screws 408 may mix the component materials together such that the resulting extruded material is a substantially homogenous or uniform physical mixture of the component materials.

The turning of the two screws 408 may advance the resulting mixture of the component materials to an output die 412 disposed at the forward or downstream end of the barrel 402. The extruder 400 may include electric heating bands 414 that supply heat to the barrel 402. The temperature of the barrel may be measured by the thermocouples 416. The heat provided by the heating bands 414 may heat the component materials as the component materials move downstream toward the output die 412. Increasing the temperature of the component materials may aid in the mixing and the extrusion of the component materials. The twin-screw extruder 400 further may include one or more de-airing ports 420 along the length of the barrel 402 that may be used to de-air the component materials as they move from the port 406 to the output die 412. The de-airing of the component materials may be done via a vacuum created at the de-airing ports 420.

The output die 412 may include an opening 418. The rotational motion of the screw 408 may drag the component materials along the extruder such that a sufficient pressure is achieved to push, i.e., extrude, the component materials through the opening 418. The opening 418 may be in the form of a thin slot, which also may be known as a sheet die. Therefore, when extruded through opening 418, the component materials may take the form of a substantially flat solidified thin sheet of material.

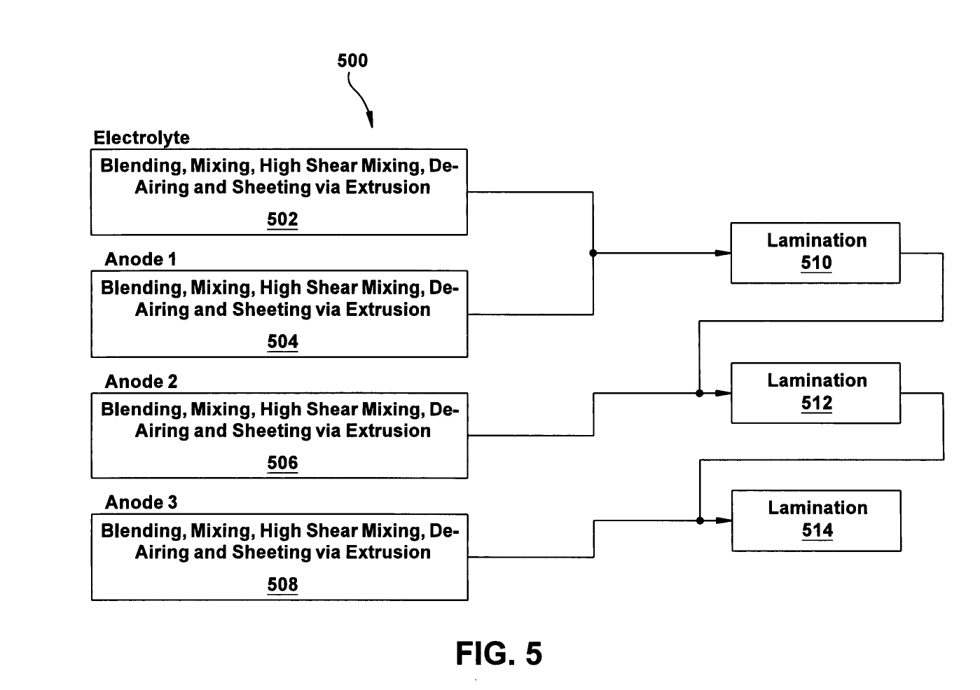

FIG. 5 demonstrates another exemplary embodiment of the present application, a twin-screw extrusion process 500, in which the fabricating process for the layers of a multilayer solid oxide fuel cell have been further simplified by using twin-screw extrusion (or, as stated, other suitable extrusion process) to reduce fabrication steps. By using a twin-screw extruder 400, the sub-processes may be simplified to a single step, i.e., the blending step, the mixing step, the high shear mixing step, the de-airing step, and the sheeting step may all take place within the twin-screw extruder 400.

Accordingly, at a step 502, the electrolyte layer may be fabricated by the twin-screw extruder 400. The electrolyte layer fabrication may include the following sequence of events. The electrolyte raw materials may be pelletized and metered into the extruder hopper 404 in the desired ratio. The action of the twin-screw extruder 400 may mix the materials into a substantially homogenous physical mixture, thus completing the previously described steps in the process 100 of blending, mixing, and high shear mixing. The mixture then may be de-aired as it travels down the barrel 402 of the twin-screw extruder through the de-airing ports 420. After the electrolyte raw materials have blended, mixed, high shear mixed, and de-aired within the barrel 402 of the twin-screw extruder 400, the resulting mixture may be forced by the turning of the twin-screws 408 through the opening 418 in the output die 412. The opening 418 may be in the form of a thin slot such that, when the mixture is extruded through the opening 418, it may take the form of a substantially flat solidified thin sheet of electrolyte material. Thus, the fabrication of a single layer of a multilayer solid oxide fuel cell may require one step (as opposed to the five process steps described above in the process 100)

This extrusion step then may be repeated for each of the other layers in the anode-electrolyte layer (see a step 504 the first anode layer, a step 506 for the second anode layer, and a step 508 for the third anode layer). Thus, the fabrication of the four layers is accomplished in four process steps (as opposed to the twenty process steps described above in the process 100).

After the four layers of the anode-electrolyte layer have been fabricated, the separate sheets may be laminated together to create the anode-electrolyte layer. The process steps required to complete the lamination may be as follows. First, at a step 510, the electrolyte layer and the first anode layer may be laminated together. Once laminated together, the resulting layer may be passed through a roll mill until its thickness is reduced to a desired measurement. At step 512, the second anode layer may be laminated to the electrolyte-first anode layer. Once these layers are laminated together, the resulting layer may be passed through a roll mill until its thickness is reduced to a desired measurement. Finally, at a step 514, the third anode layer then may be laminated to the electrolyte-first anode-second anode layer. Once these layers are laminated together, the resulting layer may be passed through a roll mill until its thickness is reduced to a desired measurement. At this point, after seven separate process steps, an anode-electrolyte layer of a multilayer solid oxide fuel cell of a desired thickness has been fabricated.

To complete the process, a cathode layer (not shown) may be fabricated using a similar process as the one described above or other process known in the art. Then, the cathode layer may then be screen printed, laminated or applied using other known processes to the anode-electrolyte layer such that a multilayer solid oxide fuel cell is formed. The multilayer solid oxide fuel cell then may be further formatted as necessary for use in fuel cell stacks to produce electricity.

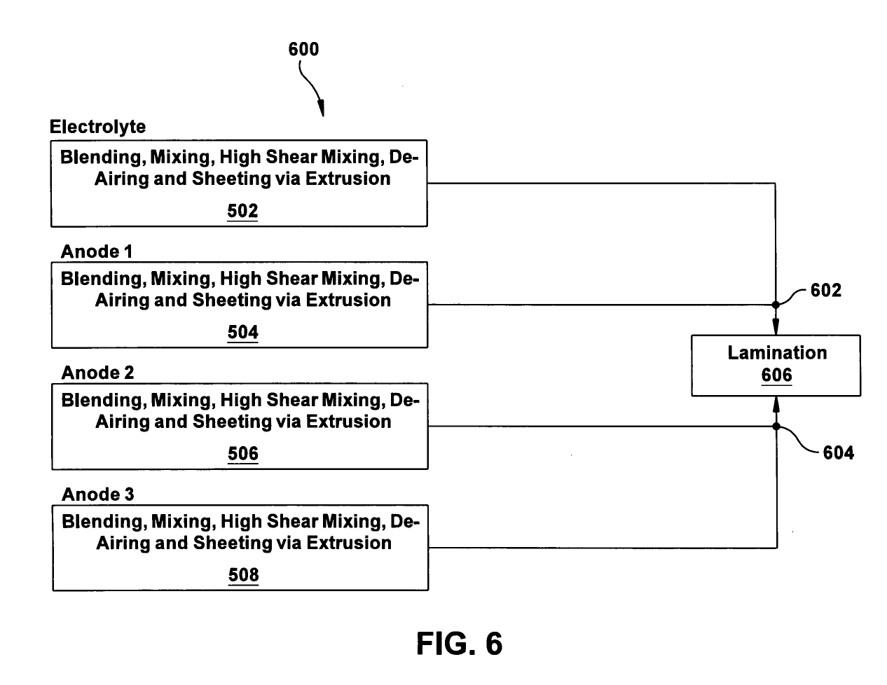

FIG. 6 demonstrates another exemplary embodiment of the present application, a co-extrusion process 600. As one of ordinary skill in the art would appreciate, co-extrusion is the process by which the output of two extruders (single-screw or twin-screw) are brought together into a single output die such that a co-extruded layer of an engineered thickness ratio is formed. Accordingly, the electrolyte layer output of step 502 of the twin-screw extrusion process 500 may be brought together with the first anode layer output of step 504 of the twin-screw extrusion process 500 (which is represented by a point 602) and co-extruded through a single output die such that the output renders a co-extruded first anode-electrolyte layer of a desired thickness ratio. Note the co-extruded layers may be of varying thicknesses. Similarly, the second anode layer output of step 506 of the twin-screw extrusion process 500 may be brought together with the third anode layer output of step 508 of the twin-screw extrusion process 500 (which is represented by a point 604) and co-extruded through a single output die such that the output renders a co-extruded second anode-third anode layer of an engineered thickness ratio. At step 606, the two co-extruded outputs may be laminated to form a multilayer anode-electrolyte layer of desired dimensions.

It should be apparent that the foregoing relates only to the described embodiments of the present application and that numerous changes and modifications may be made herein without departing from the spirit and scope of the application as defined by the following claims and the equivalents thereof.

We claim:

1. A method of fabricating a solid oxide fuel cell, comprising the steps of:
(a) inputting raw materials for a layer of the solid oxide fuel cell into a screw extruder;
(b) mixing the raw materials into a mixture as the raw materials pass through the screw extruder;
(c) de-airing the mixture of raw materials as the raw materials pass through the screw extruder; and
(d) extruding the mixture through an opening at a downstream end of the screw extruder.

2. The method of fabricating a solid oxide fuel cell according to claim 1, wherein the inputting comprises metering the raw materials into the screw extruder in a desired ratio.

3. The method of fabricating a solid oxide fuel cell according to claim 1, wherein the screw extruder comprises a twin-screw extruder.

4. The method of fabricating a solid oxide fuel cell according to claim 3, wherein the mixing comprises:
blending the raw materials as the raw materials pass through a barrel of the screw extruder; and
high shear mixing the raw materials as the raw materials pass through the barrel of the screw extruder.

5. The method of fabricating a solid oxide fuel cell according to claim 3, wherein the mixing comprises mixing the raw materials into an approximate homogeneous physical mixture.

6. The method of fabricating a solid oxide fuel cell according to claim 1, wherein the opening comprises a sheet die.

7. The method of fabricating a solid oxide fuel cell according to claim 1, wherein the opening comprises a narrow slit such that when the raw materials are extruded through the opening the raw materials form a substantially flat thin sheet.

8. The method of fabricating a solid oxide fuel cell according to claim 1, wherein the de-airing comprises creating at least a partial vacuum at one or more de-airing ports that are positioned along a barrel of the screw extruder.

9. The method of fabricating a solid oxide fuel cell according to claim 1, wherein steps (a) through (d) fabricate an electrolyte layer and a first anode layer.

10. The method of fabricating a solid oxide fuel cell according to claim 9, further comprising the steps of:
laminating the electrolyte layer to the first anode layer to create a first anode-electrolyte layer; and
passing the first anode-electrolyte layer through a roll mill as necessary to reduce the thickness of the first anode-electrolyte layer to a desired measurement.

11. The method of fabricating a solid oxide fuel cell according to claim 10, wherein steps (a) through (d) are repeated to fabricate a second anode layer;
further comprising the steps of:
laminating the second anode layer to the first anode-electrolyte layer to create a second anode-first anode-electrolyte layer; and
passing the second anode-first anode-electrolyte layer through a roll mill as necessary to reduce the thickness of the second anode-first anode-electrolyte layer to-a desired measurement.

12. The method of fabricating a solid oxide fuel cell according to claim 1, wherein steps (a) through (d) are repeated to fabricate an electrolyte layer, a first anode layer, a second anode layer, and a third anode layer.

13. The method of fabricating a solid oxide fuel cell according to claim 12, wherein the step of extruding the mixture through an opening at a downstream end of the screw extruder comprises the steps of:
co-extruding the electrolyte layer and the first anode layer such that the output renders a co-extruded electrolyte-first anode layer of a desired thickness ratio; and
co-extruding the second anode layer and the third anode layer such that the output renders a co-extruded second anode-third anode layer of a desired thickness ratio.

14. The method of fabricating a solid oxide fuel cell according to claim 13, further comprising the step of laminating the co-extruded electrolyte-first anode layer to the co-extruded second anode-third anode layer.

15. A method of fabricating a solid oxide fuel cell, comprising the steps of:
(a) blending the raw materials of a layer of the solid oxide fuel cell;
(b) mixing the raw materials of a layer of the solid oxide fuel cell;
(c) high shear mixing the raw materials of a layer of the solid oxide fuel cell;
(d) inputting the raw materials of a layer of the solid oxide fuel cell into an screw extruder;
(e) de-airing the mixture of raw materials as the raw materials pass through a barrel of the screw extruder; and
(f) extruding the mixture through a sheet die at a downstream end of the barrel.

16. The method of fabricating a solid oxide fuel cell according to claim 15, wherein the screw extruder comprises a single-screw extruder.

17. The method of fabricating a solid oxide fuel cell according to claim 15, wherein steps (a) through (f) are repeated to fabricate an electrolyte layer and a first anode layer;
further comprising the steps of:
laminating the electrolyte layer to the first anode layer to create a first anode-electrolyte layer; and
passing the first anode-electrolyte layer through a roll mill as necessary to reduce the thickness of the first anode-electrolyte layer to a desired measurement.

18. The method of fabricating a solid oxide fuel cell according to claim 17, wherein steps (a) through (f) are repeated to fabricate a second anode layer;
further comprising the steps of:
laminating the second anode layer to the first anode-electrolyte layer to create a second anode-first anode-electrolyte layer; and
passing the second anode-first anode-electrolyte layer through a roll mill as necessary to reduce the thickness of the second anode-first anode-electrolyte layer to a desired measurement.

19. The method of fabricating a solid oxide fuel cell according to claim 15, wherein steps (a) through (f) are repeated to fabricate an electrolyte layer, a first anode layer, a second anode layer, and a third anode layer; and
wherein the step of extruding the mixture through a sheet die at a downstream end of the barrel comprises the steps of:
co-extruding the electrolyte layer and the first anode layer such that the output renders a co-extruded electrolyte-first anode layer of a desired thickness ratio; and
co-extruding the second anode layer and the third anode layer such that the output renders a co-extruded second anode-third anode layer of a desired thickness ratio.

20. The method of fabricating a solid oxide fuel cell according to claim 19, further comprising the step of laminating the co-extruded electrolyte-first anode layer to the co-extruded second anode-third anode layer.
